(19) United States
(12) Patent Application Publication
(10) Pub. No.: US 2018/0051774 A1
(43) Pub. Date: Feb. 22, 2018

(54) Lateral Torque Extension Assembly and Methods of Use

(71) Applicant: Robert Campbell, West Lucama, NC (US)

(72) Inventor: Robert Campbell, West Lucama, NC (US)

(21) Appl. No.: 15/237,713

(22) Filed: Aug. 16, 2016

(51) Int. Cl. F16H 1/20; B25B 13/06; B25B 13/46; B25B 13/48

(52) U.S. Cl. CPC F16H 1/20; B25B 13/481; B25B 13/467; B25B 13/06

(57) ABSTRACT

A method and apparatus for a lateral torque extension assembly is disclosed. The assembly includes a gear train comprising a plurality of gears aligned along a longitudinal axis. The assembly includes an input drive body for receiving a rotational drive source and imparting a rotational force to one of the gears in the gear train. The assembly includes an output drive assembly having an output drive gear and an output drive body for imparting a rotational force laterally to a threaded member. The assembly has various configurations. The assembly has a first configuration where the output drive body may be mounted to a last one of the gears in the gear train and a second configuration where the output drive body may be mounted to an intermediate one of the gears in the gear train. The gear train may also be configured to accommodate two drive sources.

### TECHNICAL FIELD

The present application relates generally to a lateral torque extension assembly and particularly to a lateral torque extension assembly for adjustable laterally driving input and output drive sources.

### BACKGROUND

Tools are generally known and may be used for a great many purposes. Some of the more specific purposes may be for the application of rotational or torque related forces to threaded members, such as nuts, bolts, screws, etc. In order to apply these rotational forces, different types of tool designs exist based on the require amount of force or the location of the force. It may also be the case that the threaded members may not be in easily accessible locations. As an example, in an engine system, housing bolts, spark plugs and oxygen sensors are commonly threaded into a housing in difficult to reach areas of an engine system. When a user wishes to replace a spark plug, for example, it may be necessary to remove components of an air conditioning system of an associated automobile. Even where it is physically possible to install or remove certain threaded members, it may be inconvenient, uncomfortable, and/or or even dangerous. Since applications frequently require adjustable tool and tool assembly setups based on location of threaded members, for example, there exists a need for an adaptable tool assembly for the application of rotational forces.

### SUMMARY

A method and apparatus for a lateral torque extension assembly for tools is disclosed. The assembly includes a gear train comprising gears aligned along a longitudinal axis. The assembly includes an input drive body for receiving a rotational drive source and imparting a rotational force to one of the gears in the gear train. The assembly includes an output drive assembly having an output drive gear and an output drive body for imparting a rotational force laterally to a threaded member. The assembly has various configurations, including a configuration with the output drive body mounted to a last one of the gears in the gear train and the output drive body mounted to an intermediate gear in the gear train. The gear train may also be configured to accommodate two drive sources.

One embodiment is directed to a lateral torque extension assembly for laterally extending torque from a driving source to a socket. The extension assembly includes an arm having a linear, elongated shape, with a first arm end and a second arm end. The extension assembly also includes a gear train with a first gear, a second gear, and at least one intermediate gear that are each mounted to the arm with an elongated connector. The gear train is aligned along the arm in a first plane, and further aligned such that a center point of each of the gears is aligned in a straight line along a longitudinal axis with the first gear mounted proximate to the first arm end and the second gear mounted proximate to the second arm end. The elongated connectors extend beyond the first plane, and each gear has a through-hole at the center point. The extension assembly also includes an input drive body having a polygonal-shaped cross section with the input drive body fixedly attached to the first gear and the input drive body extends beyond the first plane.

In this embodiment, the lateral torque extension assembly also includes an output drive assembly that includes an output drive gear having a through-hole at a center point. The output drive assembly also includes an output drive bracket having a first bracket end and a second bracket end and with a first through-hole proximate to the first bracket end and a second through-hole proximate to the second bracket end. The second through-hole is aligned with the through-hole of the output drive gear. The output drive assembly also includes an output drive body having a polygonal-shaped cross section and is attached to the output drive gear such that rotation of the output drive gear causes rotation of the output drive body. The output drive assembly is mounted to the extension assembly in one of first and second configurations. The first configuration includes the output drive bracket mounted to the second gear with the elongated connector positioned through the first through-hole of the output drive bracket and the through-hole of the second gear with the output gear aligned in the first plane and engaged with the second gear and the output drive body aligned perpendicular to the first plane and extending outward beyond the second gear. The second configuration includes the output drive bracket mounted to one of the intermediate gears with the elongated connector positioned through the first through-hole of the output drive bracket and the through-hole of the intermediate gear with the output gear aligned in the first plane and engaged with the intermediate gear and the output drive body aligned perpendicular to the first plane and extending outward beyond the intermediate gear.

In this embodiment, the lateral torque extension assembly may include the output drive gear positioned at various angular orientations relative to the second gear in the first plane. The lateral torque extension assembly may also include the output drive gear positioned at various angular orientations relative to the second gear in the first plane. The elongated connectors of the lateral torque extension assembly may also be threaded members. The output drive body may also be hexagonally, spline or square shaped and in either a male or female configuration. The output drive assembly may include an extended output drive bracket having a linear, elongated shape.

In this embodiment, the input drive body may be hexagonally, spline or square shaped and in either a male or female configuration. The input drive body may also be mounted to one of the at least one intermediate gear via the elongated connector such that an applied rotational force to the input drive body imparts a rotational force to the mounted intermediate gear.

In this embodiment, the lateral torque extension assembly may also include the output drive assembly with an extended output drive bracket. The extended output drive bracket has a first end with a first through-hole and a second end with a second through-hole. This output drive assembly may also include a second gear train including a first gear, a second gear, and at least one intermediate gear that are mounted to the extended output drive bracket with an elongated connector. The second gear train is aligned along the extended output drive bracket in the first plane. The output drive assembly may also include an output drive body with a polygonal-shaped cross section and fixedly attached to either the second gear or one of the at least one intermediate gear of the second gear train such that the output drive body extends beyond the first plane. The gears of the second gear train are aligned such that a center point of each of the gears is aligned along the extended output drive bracket in a straight line along a second longitudinal axis. The extended output drive bracket has a through-hole proximate to the first end and is configured to mount to the lateral torque extension assembly according to either of the first and second configurations.

Another embodiment is directed to, a method of using a torque device to drive first and second fasteners. The method includes rotating an input drive body imparting rotation to a first gear of a gear train that is attached to the input drive body. The method also includes rotating gears of a gear train that are engaged with and that laterally extend outward away from the first gear with each of the gears of the gear train including gear teeth that extend around the periphery of the gear. The method also includes rotating an output gear that is engaged with one of the gears in the gear train with the output gear including an output drive body that is offset from the output gear. The method also includes rotating the first fastener that is engaged with the output drive body. The method also includes disconnecting the output gear from the gear in the gear train and connecting the output gear to a second one of the gears in the gear train. The method also includes rotating the input drive body and rotating the first gear attached to the input drive body and rotating the second fastener that is engaged with the output drive body.

In this embodiment, the method may also include connecting a second input drive body to a second one of the gears of the gear train. The method may also include connecting the output gear to an odd numbered one of the gears in the gear train, the odd numbered one of the gears been an odd number of gears away from the gear connected to the input drive body. The method may also include positioning the output gear such that the output gear is transverse from a longitudinal axis defining the center point of the gears of the gear train.

Another embodiment is directed to a lateral torque extension assembly for lateral torque extension from a driving source to a socket using a second input drive source. The extension assembly includes an arm having a linear, elongated shape with a first arm end and a second arm end. The extension assembly also includes a gear train with a first gear, a second gear, and at least one intermediate gear. Each of the gears is mounted to the arm with an elongated connector. The gear train is aligned along the arm in a first plane and further aligned such that a center point of each of the gears is aligned in a straight line along a longitudinal axis with the first gear mounted proximate to the first arm end and the second gear mounted proximate to the second arm end. The elongated connectors extend beyond the first plane and each gear has a through-hole at the center point. The extension assembly also includes a first input drive body having a polygonal-shaped cross section with the first input drive body fixedly attached to either the first gear or an intermediate gear and the first input drive body extends beyond the first plane. The extension assembly also includes a second input drive body having a polygonal-shaped cross section with the second input drive body fixedly attached to a different one of the at least one intermediate gears than the first input drive body. The second input drive body extends beyond the first plane.

In this embodiment, the lateral torque extension assembly also includes an output drive assembly that includes an output drive gear having a through-hole at a center point. The lateral torque extension assembly also includes an output drive bracket having a first bracket end and a second bracket end. The output drive bracket includes a first through-hole proximate to the first bracket end and a second through-hole proximate to the second bracket end. The second through-hole is aligned with the through-hole of the output drive gear. The output drive assembly also includes an output drive body having a polygonal-shaped cross section and being attached to the output drive gear such that rotation of the output drive gear causes rotation of the output drive body. The output drive assembly is configured to be mounted to the extension assembly in one of first and second configurations. The first configuration includes the output drive bracket mounted to the second gear with the elongated connector positioned through the first through-hole of the output drive bracket and the through-hole of the second gear. The output gear is aligned in the first plane and is engaged with the second gear and the output drive body aligned perpendicular to the first plane and extends outward beyond the second gear. The second configuration includes the output drive bracket mounted to one of the intermediate gears with the elongated connector positioned through the first through-hole of the output drive bracket and the through-hole of the intermediate gear. The output gear is aligned in the first plane and is engaged with the intermediate gear. The output drive body is aligned perpendicular to the first plane and extends outward beyond the intermediate gear.

In this embodiment, the lateral torque extension assembly may include the output drive gear positioned at various angular orientations relative to the second gear in the first plane. The lateral torque extension assembly may also include the output drive gear positioned at various angular orientations relative to the second gear in the first plane. The elongated connectors of the lateral torque extension assembly may also be threaded members. The output drive body may also be hexagonally, spline or square shaped and in either a male or female configuration. The output drive assembly may include an extended output drive bracket having a linear, elongated shape.

In this embodiment, the input drive body may be hexagonally, spline or square shaped and in either a male or female configuration. The input drive body may also be mounted to one of the at least one intermediate gear via the elongated connector such that an applied rotational force to the input drive body imparts a rotational force to the mounted intermediate gear.

In this embodiment, the lateral torque extension assembly may also include output drive assembly with an extended output drive bracket. The extended output drive bracket has a first end with a first through-hole and a second end with a second through-hole. This output drive assembly may also include a second gear train including a first gear, a second gear, and at least one intermediate gear that are mounted to the extended output drive bracket with an elongated connector. The second gear train is aligned along the extended output drive bracket in the first plane. The output drive assembly may also include an output drive body with a polygonal-shaped cross section and fixedly attached to either the second gear or one of the at least one intermediate gear of the second gear train such that the output drive body extends beyond the first plane. The gears of the second gear train are aligned such that a center point of each of the gears are aligned along the extended output drive bracket in a straight line along a second longitudinal axis. The extended output drive bracket has a through-hole proximate to the first end and is configured to mount to the lateral torque extension assembly according to either of the first and second configurations.

The various aspects of the various embodiments may be used alone or in any combination, as is desired.

### BRIEF DESCRIPTION OF THE DRAWINGS

Aspects of the present disclosure are illustrated by way of example and are not limited by the accompanying figures with like references indicating like elements.

FIG. 1A illustrates an example side view of a lateral torque extension assembly;

FIG. 1B illustrates a top view of the lateral torque extension assembly of FIG. 1A;

FIG. 2 illustrates a top view of the lateral torque extension assembly in a first configuration;

FIG. 3 illustrates a top view of the lateral torque extension assembly in a second configuration;

FIG. 4 illustrates a top view of the lateral torque extension assembly with an extended output drive assembly;

FIG. 5 illustrates a side view of the lateral torque extension assembly using a second input drive for the application of rotational forces; and

FIG. 6 illustrates a flow chart of a method of use of the lateral torque extension assembly.

### DETAILED DESCRIPTION

The present application discloses a lateral torque extension assembly that includes a gear train with a plurality of gears aligned along a longitudinal axis. The assembly includes an input drive body for receiving a rotational drive source (e.g., wrench) and imparting a rotational force to one of the gears in the gear train. The assembly includes an output drive assembly having an output drive gear and an output drive body that is offset from the input drive body and aligned along the longitudinal axis for imparting a rotational force to a threaded member. The assembly has a plurality of configurations. One configuration includes the output drive body mounted to the last gear in the gear train and another configuration with the output drive body mounted to one of the intermediate gears in the gear train. The gear train may also be configured to accommodate two drive sources.

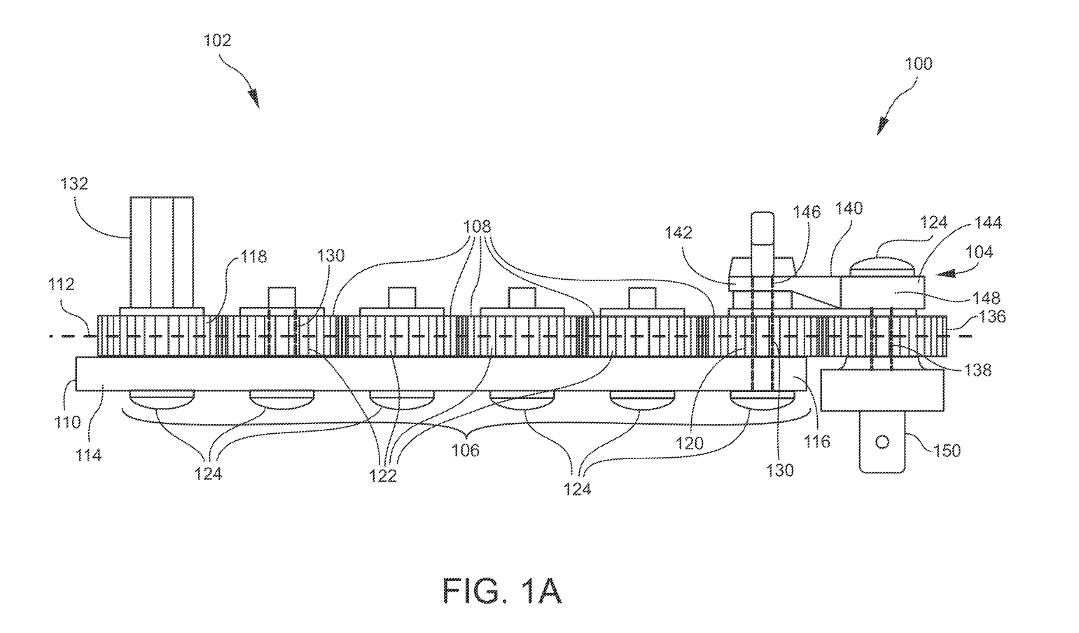

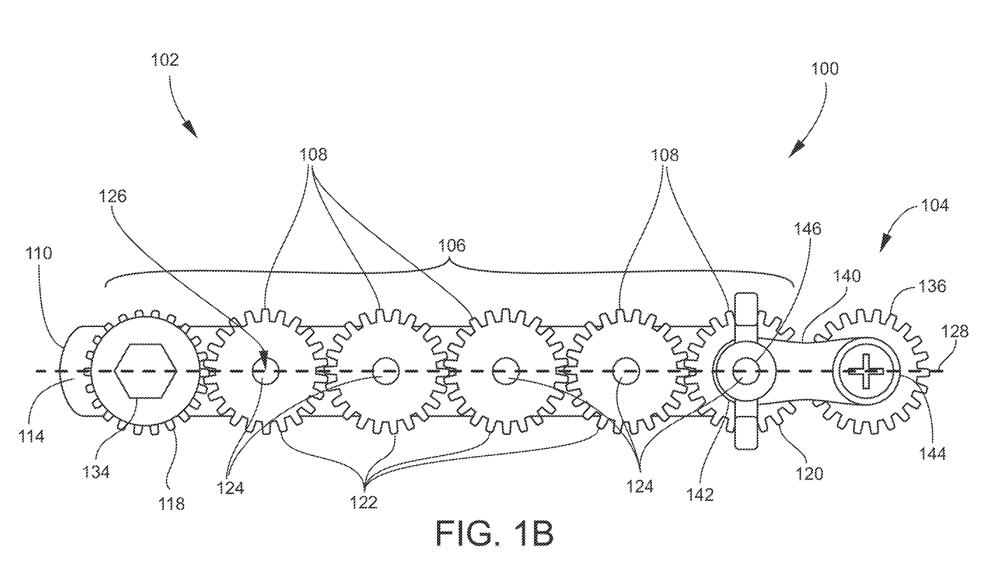

FIGS. 1A and 1B illustrate a lateral torque extension assembly 100. The lateral torque extension assembly 100 includes an extension assembly 102 and an output drive assembly 104. The extension assembly 102 may be used to laterally transfer rotational torque through a gear train 106, where the gear train includes gears 108. The extension assembly 102 also includes an arm 110 having a linear, elongated shape forming a supportive base for mounting each of the gears 108 in the gear train 106. The gears 108 of the gear train 106 are mounted in a common shared plane 112. The arm 110 also includes a first arm end 114 and a second arm end 116.

The gear train 106 includes a first gear 118, a second gear 120, and at least one intermediate gear 122 that are each mounted to the arm 110 with an elongated connector 124. The gears 108 of the gear train 106 may also be aligned linearly such that a center point 126 of each of the gears 108 are aligned in a straight line along a longitudinal axis 128. The first gear 118 may be mounted proximate to the first arm end 114 and the second gear 120 may be mounted proximate to the second arm end 116.

The elongated connectors 124 may be threaded members such as screws, bolts, rivets, etc. The elongated connectors 124 may be any connector that functions to attach any of the gears to the arm 110 in either a fixed or removable fashion. The elongated connectors 124 may be aligned perpendicular to the first plane 112 and extend beyond the first plane 112 so as to accommodate a securing body, such as a nut or rivet cap which secures the elongated connectors 124 to the extension assembly 102. Each gear 108 may have a through-hole 130 at the center point 126 of each gear 108, where each through-hole 130 may be sized to accommodate one of the elongated connectors 124.

The extension assembly 102 may also include an input drive body 132. The input drive body 132 may include a polygonal-shaped cross section 134. The input drive body 132 may be in either a male or female configuration with either the male or female configuration having a polygonal-shaped cross section 134. The polygonal-shaped cross section 134 may include any number of sides, as an example, the cross section 134 may be hexagonally or square shaped and may be of any size or dimension. As an additional example, the input drive body 132 may also be a spline drive as described herein. The input drive body 132 may be attached in a removable manner to the first gear 118. The input drive body 132 also extends beyond the first plane 112. The input drive body 132 may also be mounted to one of the intermediate gears 122 via its elongated connector 124. In each of the various configurations as a rotational force is applied to the input drive body 132, a corresponding rotational force is then imparted to the mounted gear 118, 122. This applied rotational force then imparts a rotational force to the remaining gears 108 in the gear train 106.

The input drive body 132 may also include a male/female square connection fitting (also referred to as a square drive). As an example, the sizes of the square drives may include ¼″, ⅜″, ⅝″, ½″, ¾″, 1″, 1½″, 2½″ and 3½″ square drive sizes, and both #4 and #5 spline drives specified in ANSI B107 specifications. The square drive on the input drive body 132 may attach to a rotation drive source such as a socket wrench or ratchet. The input drive body 132 may also have a male or female connection fitting which may be hexagonal in shape, or more commonly referred to as a “6-point”. Any type of cross sectional shapes of the input drive body 132 may be used. The input drive body 132 may be driven by being attached to a rotation drive source via the connection fitting. This connection fitting provides for a wide variety of types and sizes of drive sources. The input drive body 132 may include a retaining ring with O-ring and pin type, single piece moulded retaining rings, a locking pin, or friction ball. The retaining ring with O-ring and pin, the single piece moulded retaining rings, locking pin or friction ball may be formed into either the input drive body 132 or the drive source to facilitate attachment. Some common hand ratchets (e.g., a rotational drive source) employ a quick release button on their top for quick socket release of smaller sockets. This same type of mechanism may also be incorporated into the input drive body 132.

The lateral torque extension assembly 100 also includes the output drive assembly 104. The assembly 104 includes an output drive gear 136 having a through-hole 138 at a center point. The output drive assembly 104 also includes an output drive bracket 140 with a first end 142 and a second end 144. The output drive bracket 140 includes a first through-hole 146 proximate to the first end 142 and a second through-hole 148 proximate to the second end 144. The second through-hole 148 may be aligned with the through-hole 138 of the output drive gear 136.

The output drive assembly 104 also includes an output drive body 150 having a polygonal-shaped cross section. The output drive body 150 is either fixedly or removably attached to the output drive gear 136 such that rotation of the output drive gear 136 causes rotation of the output drive body 150. Similar to the input drive body 132, the output drive body 150 may be hexagonally or square shaped so as to accommodate a socket or other fastener driving means. Additionally, the output drive body 150 may be a spline drive, as described herein.

The output drive body 150 may also include a male/female square connection fitting (also referred to as the square drive). As an example, the sizes of square drives may include ¼″, ⅜″, ⅝″, ½″, ¾″, 1″, 1½″, 2½″ and 3½″ square drive sizes, additionally #4 and #5 spline drives specified in ANSI B107 specifications. The square drive drives sockets which may be hexagonal, or more commonly referred to as a “6-point”. Other types of sockets with various shaped cross sections may also be driven by the output drive body 150. This wide range of square drive sizes provides for a wide variety of socket types and sizes to suit small to very large nuts, bolts and other threaded members. In the sockets, some square drives have a through-hole to attach the socket to the output drive body 150 using a retaining ring with O-ring and pin type, single piece moulded retaining rings, a locking pin, or friction ball. The retaining ring with O-ring and pin, the single piece moulded retaining rings, locking pin or friction ball may be formed into either the output drive body 150 or the socket to facilitate attachment. Some common hand ratchets (e.g., a rotational drive source) employ a quick release button on their top for quick socket release of smaller sockets. This same type of mechanism may also be incorporated into the output drive assembly.

A socket may be a cylinder which has a female six- or twelve-point recessed opening sized to fit over the common male hexagonal head of a bolt/nut fastener or other threaded member. The opposite end of the socket may include a standardized (ANSI B107, ISO, or other consensus standard) square recess to accept the size of the output drive body's square drive size. The sockets are interchangeable and may accommodate any fastener type. The principal advantage of interchangeable sockets is that, instead of a separate wrench for each of the many different fastener sizes and types, only separate sockets are needed for each size and type. Because of the versatility of the socket, nearly all screw, bolt and fastener types have sockets of different types made to fit their bolt or nut shapes.

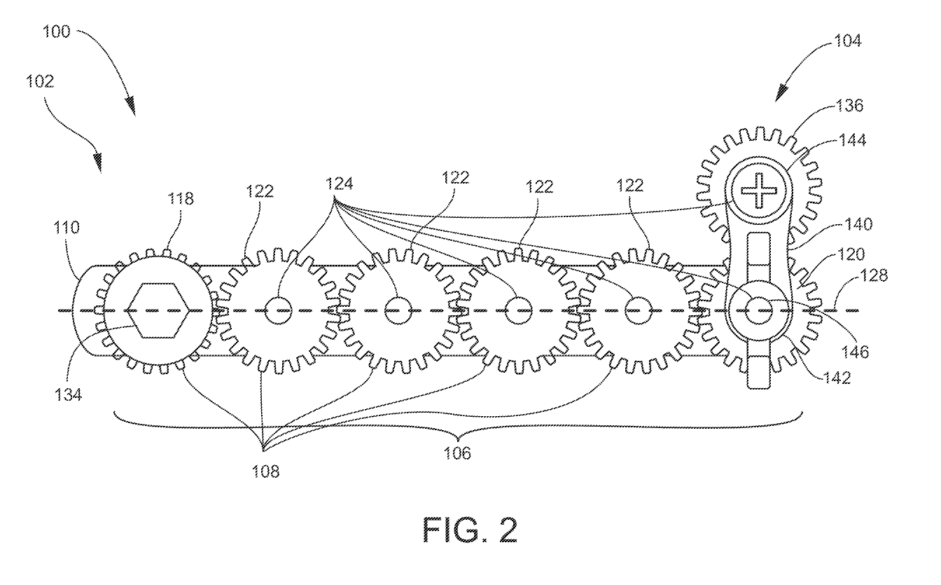

The output drive assembly 104 may also be configured to be mounted to the extension assembly 102 in one of a plurality of configurations. Another configuration, as illustrated in FIG. 2, includes the output drive bracket 140 mounted to the second gear 120 with the elongated connector 124 positioned through the first through-hole 146 of the output drive bracket 140 and the through-hole 130, as illustrated in FIG. 1A, of the second gear 120. The output drive gear 136 may be aligned in the first plane 112, as illustrated in FIG. 1A, and may be engaged with the second gear 120. The output drive body 150, as illustrated in FIG. 1A, may be aligned perpendicular to the first plane 112 and extend outward beyond the second gear 120. In this embodiment, the output drive gear 136 may be positioned at different angular orientations around the second gear 120 in the first plane 112 while remaining engaged with the second gear 120. The different angular orientations around the second gear 120 may vary up to 90 degrees in either direction relative to the longitudinal axis 128. Thus, the output drive body 150 may be positioned so as to accommodate various positions of the fastener or threaded member relative to the extension assembly 102.

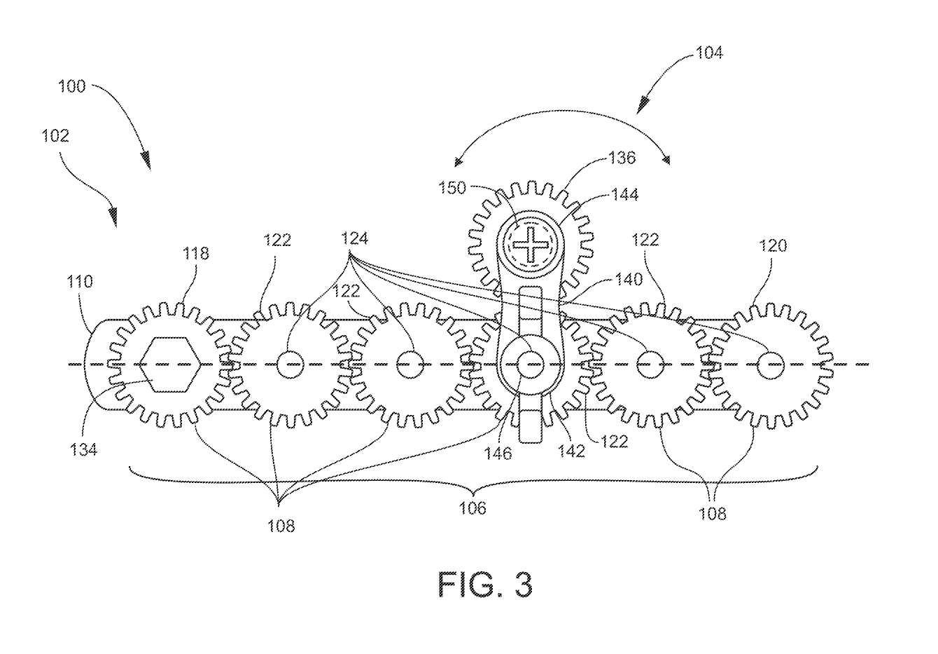

FIG. 3 illustrates a configuration with the output drive assembly 104 mounted to the extension assembly 102 such that the output drive bracket 140 may be mounted with the elongated connector 124 positioned through the first through-hole 146 of the output drive bracket 140 and the through-hole 130 of an intermediate gear 122. The output drive gear 136 may be aligned in the first plane 112 and may be engaged with the intermediate gear 122. The output drive body 150 may be aligned perpendicular to the first plane 112 and extend outward beyond the intermediate gear 122.

In the configuration as illustrated in FIG. 3, the output drive gear 136 may be positioned at various angular orientations on one side of the gear train 106 in the first plane 112 while remaining engaged with the intermediate gear 122. Similar to the embodiment in FIG. 2, by repositioning and reengaging the output drive gear 136 to one of the intermediate gears 122, a virtually unlimited number of positions may be achieved for imparting rotational forces to threaded members or fasteners. Additionally, the different angular orientations around the intermediate gear 122 may be any angular orientation such that the output drive gear 136 does not interfere with a neighboring gear 108 that is adjacent to the engaged intermediate gear 122.

The output drive assembly 104 may have different lengths to engage with fasteners that are located different distances away from the longitudinal axis 128. This may include the output drive bracket 140 having different lengths, and one or more additional gears located along the output drive bracket 140.

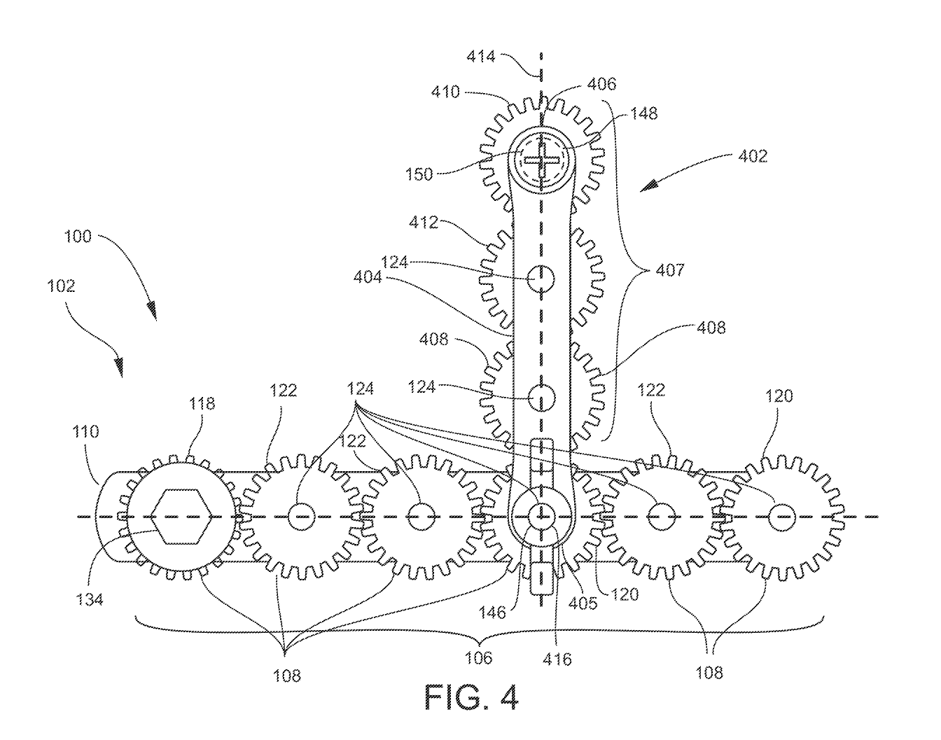

FIG. 4 illustrates a torque assembly 100 with an extended output drive assembly 402. The extended output drive assembly 402 includes an extended output drive bracket 404 having a linear, elongated shape. The extended output drive bracket 404 includes a first end 405 with a first through-hole 146 and a second end 406 with a second through-hole 148. The extended output drive assembly 402 includes a second gear train 407 including a first gear 408, a second gear 410, and at least one intermediate gear 412 with each of the gears mounted to the extended output drive bracket 404 with an elongated connector 124. The second gear train 407 is aligned along the extended output drive bracket 404 in the first plane 112 such that the first gear 408 engages with a gear on the gear train 106.

The extended output drive assembly 402 includes an output drive body 150. The body 150 may include various shapes, including a polygonal-shaped cross section. The output drive body 150 may be either fixedly or removably engaged with the various gears along the assembly 402. This provides for positioning the body 150 at a location to engage with the member or fastener that is to be worked on.

The gears of the second gear train 407 may be aligned such that a center point of each of the gears is aligned along the extended output drive bracket 404 in a straight line along a second longitudinal axis 414. The extended output drive bracket 404 may include a through-hole 416 proximate to the first end 405 and configured to mount to the lateral extension assembly 102 as described in accordance with FIG. 2 or 3. Thus, the extended output drive assembly 402 may be moved or repositioned in a similar fashion to the output drive assembly 104 as discussed in FIGS. 2 and 3.

In the various configurations, the device may include one or more output drive assemblies 104 or extended output drive assemblies 402. The different combinations of components provide for accommodating one or more threaded members or fasteners in more difficult locations or requiring an extend reach may be accommodated.

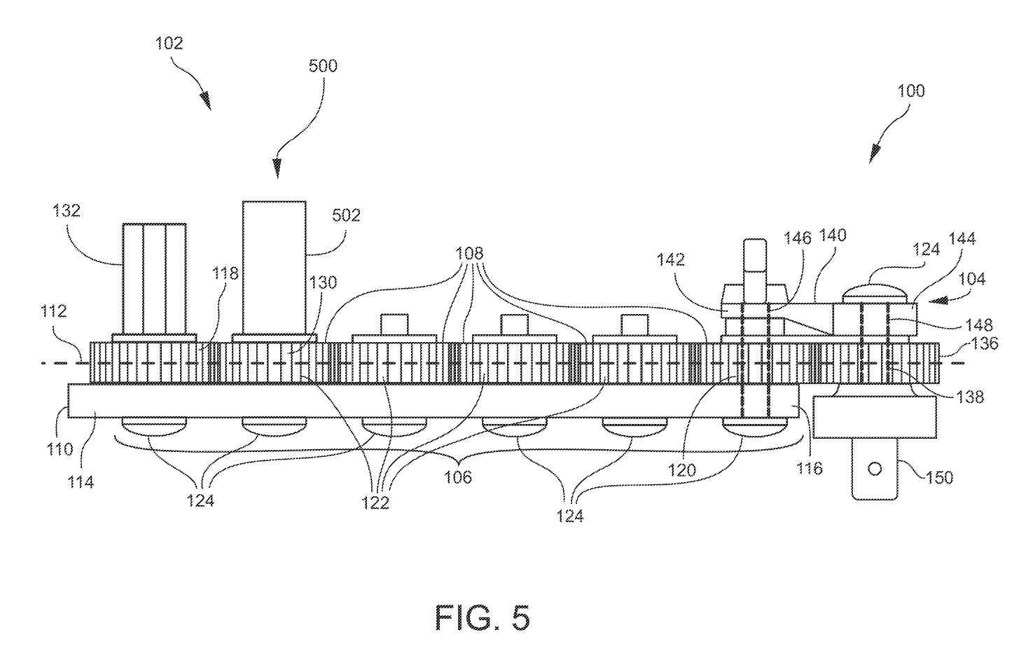

The extension assembly 102 may include a single drive source as illustrated in FIGS. 1A-4. The single drive source provides for the application of force to impart a rotational force to the gear train 106. The extension assembly 102 may also be configured to receive forces from two or more different drive sources. FIG. 5 includes an embodiment to accommodate two force input sources. The assembly 102 includes the first input drive body 132 to receive a first drive force and a second input drive body 502 to receive a second drive force.

The second input drive body 502 may have a polygonal-shaped cross section and extends beyond the first plane 112 to engage with a drive source. The second input drive body 502 is either fixedly or removably attached to a different one of the intermediate gears 122 than the first input drive body 132. This embodiment applies rotational force to the gear train 106 through each of the first input drive body 132 and the second input drive body 502. As illustrated in FIG. 5, input drive assemblies, 132, 502 may be attached to the gear train 106 as desired. For example, depending upon the confines of space, a user may desire to loosen a bolt by rotating a wrench attached to the first input drive body 132, the user may also attach a wrench to the second input drive body 502 and operate the extension assembly 102 with one hand by converging the drive wrenches together. Connecting input drive bodies 132, 502 to adjacent gears allows for sockets, wrenches, etc. to be actuated for torque transmission using one hand.

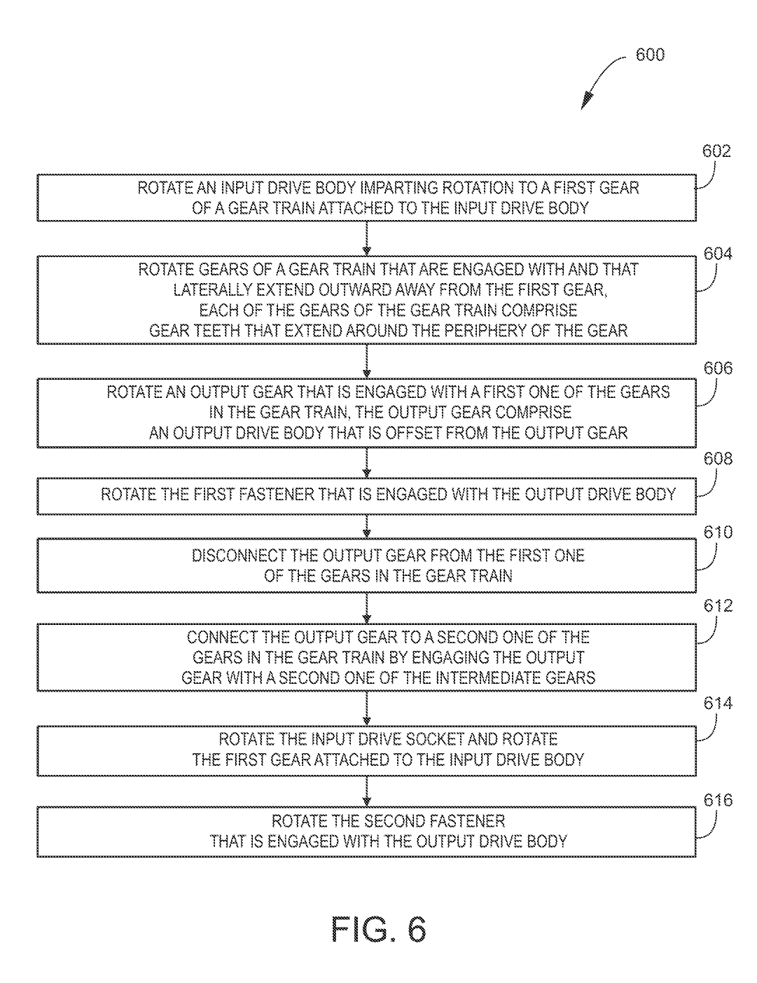

A method 600 of using a torque device to drive first and second fasteners (e.g., nuts, bolts, screws, threaded bodies, etc.) is illustrated in FIG. 6. The method 600 includes rotating an input drive body which in turn imparts rotation to a connected first gear (block 602). The rotation of the first gear causes rotation of one or more additional gears. The additional gears are part of a gear train that is engaged with and that laterally extends outward away from the first gear along a longitudinal axis (block 604). Each of the gears includes gear teeth that extend around the periphery of the gear and are engaged with one or more adjacent gears. The rotation of the gears of the gear train causes rotation of an output gear (block 606). The output gear includes an offset output drive body. The output drive body is engaged with a first fastener such that the rotation of the input drive body is transferred to the output drive body to turn the first fastener (block 608).

After turning the first fastener the desired amount, the device can be re-oriented to turn a second fastener. This includes disconnecting the output gear from the gear to which it is connected when working on the first fastener (block 610). The output gear is then connected to a different gear along the gear train. This includes engaging the teeth on the output gear with corresponding teeth on the new gear (block 612). By disconnecting and re-connecting the output gear to a different one of the gears in the gear train, the lateral torque extension assembly may be adjusted to accommodate different requirements for directing a rotational force to the fasteners. For example, while the extension assembly may be of various lengths, by disconnecting the output drive gear from a first gear and reconnecting it to a different gear, the effective length, reach or configuration for the lateral extension for driving fasteners may be appropriately adjusted.

Once the output gear is connected to the new gear, the input drive body is rotated thus causing rotation of the first gear and the gears in the gear train (block 614). This rotational force ultimately drives the output drive gear which in turn rotates the second fastener that is engaged with the output drive body (block 616).

The method 600 may also include connecting a second input drive body, as illustrated in FIG. 5, to one of the gears of the gear train. In this manner, the extension assembly may provide for additional rotational drive force to be applied to the output drive body.

The method 600 may also include connecting the output drive gear to an odd numbered one of the gears in the gear train. The odd numbered one of the gears being an odd number of gears away from the gear connected to the input drive body. By connecting the output drive gear to an odd numbered one of the gears in the gear train, the lateral torque extension assembly may drive a fastener or threaded member in the same direction as the rotational force imparted to the input drive gear.

Additionally, the output drive gear may also include connecting the output drive gear to an even numbered one of the gears in the gear train. The even numbered one of the gears being an even number of gears away from the gear connected to the input drive body. By connecting the output drive gear to an even numbered one of the gears in the gear train, the lateral torque extension assembly may drive a fastener or threaded member in the opposite direction as the rotational force imparted to the input drive gear.

Additionally, the method 600 may include positioning the output drive gear such that it is transverse or offset from the longitudinal axis defining the center point of the gears of the gear train, while the output drive gear remains in the first plane.

The present invention may be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A lateral torque extension assembly for laterally extending torque from a driving source to a socket comprising:
an extension assembly, comprising:
an arm having a linear, elongated shape, the arm having a first arm end and a second arm end; and
a gear train comprising a first gear, a second gear, and at least one intermediate gear that are each mounted to the arm with an elongated connector, the gear train being aligned along the arm in a first plane, and further aligned such that a center point of each of the gears are aligned in a straight line along a longitudinal axis, wherein the first gear is mounted proximate to the first arm end and the second gear is mounted proximate to the second arm end, and wherein the elongated connectors extend beyond the first plane, and wherein each gear has a through-hole at the center point;
an input drive body having a polygonal-shaped cross section, wherein the input drive body is fixedly attached to the first gear, and wherein the input drive body extends beyond the first plane; and
an output drive assembly comprising:
an output drive gear having a through-hole at a center point;
an output drive bracket having a first bracket end and a second bracket end, wherein the output drive bracket comprises a first through-hole proximate to the first bracket end and a second through-hole proximate to the second bracket end, the second through-hole is aligned with the through-hole of the output drive gear; and
an output drive body having a polygonal-shaped cross section and being attached to the output drive gear such that rotation of the output drive gear causes rotation of the output drive body;
wherein the output drive assembly is configured to be mounted to the extension assembly in one of first and second configurations:
the first configuration comprising the output drive bracket mounted to the second gear with the elongated connector positioned through the first through-hole of the output drive bracket and the through-hole of the second gear, wherein the output gear is aligned in the first plane and is engaged with the second gear and the output drive body is aligned perpendicular to the first plane and extends outward beyond the second gear; and
the second configuration comprising the output drive bracket mounted to one of the at least one intermediate gear with the elongated connector positioned through the first through-hole of the output drive bracket and the through-hole of the intermediate gear, wherein the output gear is aligned in the first plane and is engaged with the intermediate gear and the output drive body is aligned perpendicular to the first plane and extends outward beyond the intermediate gear.

2. The lateral torque extension assembly of claim 1, wherein in the first configuration, the output drive gear is positioned at varying angular orientations up to 90 degrees around the second gear relative to the longitudinal axis in the first plane.

3. The lateral torque extension assembly of claim 1, wherein in the second configuration, the output drive gear is positioned on one side of the gear train at a variable angular orientation around an attached intermediate gear in the first plane.

4. The lateral torque extension assembly of claim 1, wherein the elongated connectors are threaded.

5. The lateral torque extension assembly of claim 1, wherein the polygonal-shaped cross section of the input drive body is one of hexagonally or square shaped.

6. The lateral torque extension assembly of claim 1, wherein the polygonal-shaped cross section of the output drive body is one of hexagonally or square shaped.

7. The lateral torque extension assembly of claim 1, wherein the output drive assembly comprises:
an extended output drive bracket having a linear, elongated shape, the extended output drive bracket having a first end with a first through-hole and a second end with a second through-hole;
a second gear train comprising a first gear, a second gear, and at least one intermediate gear that are each mounted to the extended output drive bracket with an elongated connector, the second gear train being aligned along the extended output drive bracket in the first plane; and
an output drive body having a polygonal-shaped cross section and fixedly attached to either the second gear or one of the at least one intermediate gear of the second gear train such that the output drive body extends beyond the first plane;
wherein the gears of the second gear train are aligned such that a center point of each of the gears are aligned along the extended output drive bracket in a straight line along a second longitudinal axis;
wherein the extended output drive bracket has a through-hole proximate to the first end and is configured to mount to the extension assembly according to either of the first and second configurations.

8. The lateral torque extension assembly of claim 1, wherein the input drive body is mounted to one of the at least one intermediate gear via the elongated connector, wherein an applied rotational force to the input drive body imparts a rotational force to the mounted intermediate gear.

9. A method of using a torque device to drive first and second fasteners, the method comprising:
rotating an input drive body imparting rotation to a first gear of a gear train attached to the input drive body;
rotating gears of a gear train that are engaged with and that laterally extend outward away from the first gear, each of the gears of the gear train comprising gear teeth that extend around the periphery of the gear;
rotating an output gear that is engaged with a first one of the gears in the gear train, the output gear comprising an output drive body that is offset from the output gear;
rotating the first fastener that is engaged with the output drive body;
disconnecting the output gear from the first one of the gears in the gear train;
connecting the output gear to a second one of the gears in the gear train by engaging the output gear with a second one of the intermediate gears;
rotating the input drive body and rotating the first gear attached to the input drive body; and
rotating the second fastener that is engaged with the output drive body.

10. The method of claim 9, further comprising:
connecting a second input drive body to a second one of the gears of the gear train.

11. The method of claim 9, further comprising:
connecting the output gear to an odd numbered one of the gears in the gear train, the odd numbered one of the gears been an odd number of gears away from the gear connected to the input drive body.

12. The method of claim 9, further comprising:
positioning the output gear such that the output gear is transverse from a longitudinal axis defining the center point of the gears of the gear train.

13. A lateral torque extension assembly for lateral torque extension from a driving source to a socket comprising:
an extension assembly, comprising:
an arm having a linear, elongated shape, the arm having a first arm end and a second arm end; and
a gear train comprising a first gear, a second gear, and at least one intermediate gear that are each mounted to the arm with an elongated connector, the gear train being aligned along the arm in a first plane, and further aligned such that a center point of each of the gears are aligned in a straight line along a longitudinal axis, wherein the first gear is mounted proximate to the first arm end and the second gear is mounted proximate to the second arm end, and wherein the elongated connectors extend beyond the first plane, and wherein each gear has a through-hole at the center point;
an first input drive body having a polygonal-shaped cross section, wherein the first input drive body is fixedly attached to either the first gear or one of the at least one intermediate gear, and wherein the first input drive body extends beyond the first plane;
a second input drive body having a polygonal-shaped cross section, wherein the second input drive body is fixedly attached to a different one of the at least one intermediate gears than the first input drive body, and wherein the second input drive body extends beyond the first plane; and
an output drive assembly comprising:
an output drive gear having a through-hole at a center point;
an output drive bracket having a first bracket end and a second bracket end, wherein the output drive bracket comprises a first through-hole proximate to the first bracket end and a second through-hole proximate to the second bracket end, the second through-hole is aligned with the through-hole of the output drive gear; and
an output drive body having a polygonal-shaped cross section and being attached to the output drive gear such that rotation of the output drive gear causes rotation of the output drive body;
wherein the output drive assembly is configured to be mounted to the extension assembly in one of first and second configurations:
the first configuration comprising the output drive bracket mounted to the second gear with the elongated connector positioned through the first through-hole of the output drive bracket and the through-hole of the second gear, wherein the output gear is aligned in the first plane and is engaged with the second gear and the output drive body is aligned perpendicular to the first plane and extends outward beyond the second gear; and
the second configuration comprising the output drive bracket mounted to one of the at least one intermediate gear with the elongated connector positioned through the first through-hole of the output drive bracket and the through-hole of the intermediate gear, wherein the output gear is aligned in the first plane and is engaged with the intermediate gear and the output drive body is aligned perpendicular to the first plane and extends outward beyond the intermediate gear.

14. The lateral torque extension assembly of claim 1, wherein in the first configuration, the output drive gear is positioned at varying angular orientations up to 90 degrees around the second gear relative to the longitudinal axis in the first plane.

15. The lateral torque extension assembly of claim 1, wherein in the second configuration, the output drive gear is positioned on one side of the gear train at a variable angular orientation around an attached intermediate gear in the first plane.

16. The lateral torque extension assembly of claim 1, wherein the elongated connectors are threaded.

17. The lateral torque extension assembly of claim 1, wherein the polygonal-shaped cross section of the input drive body is one of hexagonally or square shaped.

18. The lateral torque extension assembly of claim 1, wherein the polygonal-shaped cross section of the output drive body is one of hexagonally or square shaped.

19. The lateral torque extension assembly of claim 1, wherein the output drive assembly comprises:
an extended output drive bracket having a linear, elongated shape, the extended output drive bracket having a first end with a first through-hole and a second end with a second through-hole;
a second gear train comprising a first gear, a second gear, and at least one intermediate gear that are each mounted to the extended output drive bracket with an elongated connector, the second gear train being aligned along the extended output drive bracket in the first plane; and
an output drive body having a polygonal-shaped cross section and fixedly attached to either the second gear or one of the at least one intermediate gear of the second gear train such that the output drive body extends beyond the first plane;
wherein the gears of the second gear train are aligned such that a center point of each of the gears are aligned along the extended output drive bracket in a straight line along a second longitudinal axis;
wherein the extended output drive bracket has a through-hole proximate to the first end and is configured to mount to the extension assembly according to either of the first and second configurations.
